(19) United States
(12) Patent Application Publication
(10) Pub. No.: US 2026/0314533 A1
(43) Pub. Date: Oct. 15, 2026

(54) METHOD AND APPARATUS FOR PRECISION HARVESTING OF CROPS WITH CONTROLLED STEM LENGTH

(71) Applicants: Alaeddin BANI MILHIM, Fresno, CA (US); The NGUYEN, Fresno, CA (US); Juan Nieto ESPINOZA, JR., Shafter, CA (US); Brendan CHINNOCK, Clovis, CA (US); Ariana RAJABI, Clovis, CA (US); Caleb BAHNE, Kingsburg, CA (US)

(72) Inventors: Alaeddin BANI MILHIM, Fresno, CA (US); The NGUYEN, Fresno, CA (US); Juan Nieto ESPINOZA, JR., Shafter, CA (US); Brendan CHINNOCK, Clovis, CA (US); Ariana RAJABI, Clovis, CA (US); Caleb BAHNE, Kingsburg, CA (US)

(73) Assignee: California State University, Fresno, Fresno, CA (US)

(21) Appl. No.: 19/467,700

(22) Filed: Feb. 2, 2026

Related U.S. Application Data
(60) Provisional application No. 63/754,529, filed on Feb. 5, 2025.

(51) Int. Cl. A01D 46/30; A01D 46/253; G06T 1/00; G06T 7/70; G06V 20/68

(52) U.S. Cl. CPC A01D 46/30; A01D 46/253; G06T 1/0014; G06T 7/70; G06V 20/68; G06T 2207/30188

(57) ABSTRACT

A fruit harvesting system and a method of harvesting fruit are disclosed. The system includes a platform, a robotic arm mounted on the platform, an end effector configured to grasp a fruit and sever a stem of the fruit with a controlled residual stem length, and a recognition system. The robotic arm has multiple degrees of freedom. The end effector is operably connected to the robotic arm and includes a gripper having a plurality of rotatable fingers configured to open and close around the fruit, and a cutting mechanism configured to sever the stem of the fruit when the rotatable fingers close around the fruit. The recognition system is configured to identify a location of the fruit and instruct the robotic arm to guide the end effector to the location of the fruit.

### CROSS-REFERENCE TO RELATED APPLICATIONS

This application claims priority to U.S. Provisional Pat. Appl. No. 63/754,529, filed on Feb. 5, 2025, the contents of which are incorporated by reference herein in its entirety.

### FIELD OF THE INVENTION

The present invention generally relates to the field of agriculture. More specifically, embodiments of the present invention pertain to an apparatus and method for harvesting crops having stems, and controlling the length of the stem remaining on the crops after harvesting.

### DISCUSSION OF THE BACKGROUND

Current harvesting systems are effective for more durable plants, such as nuts, or juice-grade fruits. However, soft fruits and vegetables can sustain bruising and skin damage with the current techniques, which lowers their market value and shelf life. Table-grade fruits, for example, require precise stem length tolerances to preserve shelf life. Automated methods using pulling or picking often remove the whole stem along with the calyx, reducing the shelf life of the picked crop. Current automated cutting methods tend to leave the stem too long, causing fruits and other relatively soft crops to bruise or puncture each other during transport. Therefore, it is necessary to develop a system capable of harvesting crops at consistent, desired stem lengths.

Current automated citrus harvesting methods using pulling or picking either remove the whole stem along with the calyx or leave the stem too long. Both outcomes negatively impact the fruit's quality by either reducing its shelf life or increasing the risk of bruising and puncturing during transport. Therefore, it is necessary to develop a system capable of harvesting crops at consistent, desired stem lengths.

Existing systems pick citrus, for example, by twisting it or cutting it with a lengthy stem, or with no stem at all. Removing the stem from a harvested crop allows bacteria, fungi, and other organisms and contaminants to enter, causing rot and reducing shelf life. Leaving a lengthy stem can cause the crop to bruise and puncture each other while being transported, reducing their quality and profitability.

For example, CN 109105001 B discloses an end effector for a bergamot pear picking robot and picking method. CN 214592967 U discloses a three-finger spherical end effector for an orange picking robot. CN 213662539 U discloses an end effector for an orange picking robot. CN 208258442 U discloses a kind of end effector for a spherical fruit picking robot. CN 117063716 A discloses a citrus tail end picking hand capable of breaking stems through spherical enveloping and occlusion. U.S. Pat. No. 10,757,861 discloses a robotic fruit picking system. CN 115004946 A discloses a flexible active swallowing type harvesting end effector system for picking small spherical fruits. WO 2016/055552 A1 discloses an automated harvesting apparatus.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

It is desired to develop a system capable of harvesting crops at consistent, desired stem length. The present invention extends automated agriculture techniques to high-quality spherical crops.

Thus, one aspect of the present invention concerns a fruit harvesting system, comprising a platform; a robotic arm mounted on the platform, the robotic arm having a plurality of degrees of freedom; an end effector configured to grasp a fruit and sever a stem of the fruit, the end effector being operably connected to the robotic arm; and a recognition system configured to identify a location of the fruit and instruct the robotic arm to guide the end effector to the location of the fruit. The end effector comprises a gripper having a plurality of rotatable fingers configured to open and close around the fruit, and a cutting mechanism configured to sever the stem of the fruit when the rotatable fingers close around the fruit.

In certain embodiments of the fruit harvesting system, the end effector further comprises a V-shaped guide configured to guide the stem into a cutting position in the cutting mechanism. In other or further embodiments, the cutting mechanism may comprise first and second opposing blades (or a blade and an opposing surface) configured to cut the stem by moving towards each other, and the V-shaped guide has a base or crux that at least partially overlaps the first and second opposing blades.

In most embodiments, the robotic arm has three or more degrees of freedom (e.g., six degrees of freedom). However, it is possible for the robotic arm to have one degree or two degrees of freedom, and the platform may provide additional (e.g., the remaining) degrees of freedom. In general, the robotic arm includes a plurality of links or arms, and adjacent ones of the links or arms are connected by a joint. In such cases, the present fruit harvesting system may further comprise an actuator for each joint, configured to drive the joint and/or move a corresponding one of the links or arms rotationally and/or translationally.

Alternatively or additionally, the platform may comprise one or more stages configured to raise and lower the robotic arm vertically, extend or retract the robotic arm horizontally, and/or rotate the stage(s) or the robotic arm in a horizontal plane. The platform may be autonomous, and may comprise three or more wheels and a power system configured to drive the wheels in at least one direction.

In some embodiments, the gripper comprises three or more gripper fingers, each configured to rotate (e.g., around an axle, hinge or bearing secured to the gripper) to open and close the gripper around the fruit. In other or further embodiments, the gripper further comprises a palm, designed to hold and center the fruit, in combination with the gripper fingers.

In various embodiments, the end effector further comprises a first actuator configured to cause the gripper fingers to grip and release the fruit. In other or further embodiments, the end effector further comprises a fixed gripper plate, a movable gripper plate or frame, and a rod or bearing attached to the movable gripper plate or frame. In such embodiments, the first actuator may configured to move the movable gripper plate or frame linearly along an axis defined by or parallel to a central axis of the gripper fingers by extending the rod or bearing, and each of the gripper fingers may be hingedly connected to each of the fixed gripper plate and the movable gripper plate or frame. Furthermore, the rod or bearing attached to the movable gripper plate or frame may be a bearing, in which case the first actuator may comprise a motor that rotates an axle (e.g., extending from a housing of the first actuator) and a rotating arm extending perpendicularly from the axle, the rotating arm may be coupled to the bearing, and the first actuator may rotate or sweep the rotating arm periodically (e.g., back and forth) across a fixed arc (e.g., from +90° to −90° relative to the central axis of the gripper fingers, or any range of degrees therein) to extend the movable gripper plate or frame from a position near the fixed support plate to a position near the fixed gripper plate and back.

Additionally or alternatively, the end effector may further comprise a second actuator configured to move the first and second blades (or the blade and the opposing surface) of the cutting mechanism towards and away each other.

In further embodiments, the fruit harvesting system may further comprise a computer system configured to receive image data from the recognition system, identify the fruit from the image data, determine a position of the fruit and identify an orientation of the stem from the image data and positioning information, and/or control motion of the robotic arm to guide the end effector toward the fruit from the position of the fruit and the orientation of the stem. In some implementations, the computer and/or recognition system(s) may determine the position and orientation of the fruit, as well as a size of the fruit (e.g., to determine an opening angle of the gripper fingers in embodiments where the opening angle can be varied). In other or further implementations, the computer and/or recognition system(s) may determine the position and orientation of the stem, although the position of the stem can, in some embodiments, be estimated from the size of the fruit. Additionally or alternatively, the fruit harvesting system may also further comprise a wireless communication module (e.g., in the recognition system, on the robotic arm) that communicates wirelessly with the computer system.

Another aspect of the present invention concerns a method of harvesting fruit, comprising detecting a fruit connected to a tree through a stem using a recognition system; moving an end effector using a robotic arm to a position offset from the fruit; gripping the fruit with a gripper in the end effector; and severing the stem with a cutting mechanism in the end effector. As for the present harvesting system, the end effector comprises the gripper, which has a plurality of rotatable fingers configured to open and close around the fruit, and the cutting mechanism, which is configured to sever the stem of the fruit when the rotatable fingers close around the fruit.

In various embodiments, the method may further comprise adjusting the position of the end effector so that the stem enters a V-guide on the end effector. The V-guide may be aligned with and/or positioned adjacent to the cutting mechanism so that the cutting mechanism can sever the stem when the stem is in the V-guide (e.g., in or at a base or crux of the V-guide).

In other or further embodiments, the method may further comprise moving a platform on which the robotic arm is mounted to a location under or adjacent to the tree. In typical operations, the method further comprises repeating the method for additional pieces of fruit.

In various embodiments, detecting the fruit may comprise generating image data of the fruit and its surrounding environment with a camera in the recognition system, transferring the image data to a computer system, and processing the image data with the computer system to recognize and determine locations of the fruit and the stem and determine one or more characteristics of the fruit (e.g., a length, width, and/or diameter) and/or an orientation of the stem. Additionally or alternatively, moving the end effector may comprise sending one or more instructions from the computer system to the robotic arm to move in a plurality of directions until the end effector is in the position offset from the fruit. The position offset from the fruit may be such that the gripper fingers can surround the fruit by moving the end effector along a single angular or linear direction a distance of not more than three times a length of the gripper or gripper fingers.

Yet another aspect of the present invention concerns a non-transitory computer-readable medium, comprising a set of instructions encoded thereon or therein and, when executed by a processing device, is adapted to practice any and/or all aspects of the method(s) described herein.

Current harvesting systems are generally effective for more durable crops and plants, such as nuts, or for juice-grade fruits, where the appearance and quality of the fruit is not as important as for table-grade fruits. The present system controls lateral and vertical motions of the end effector to actively align the stem with the cutting mechanism, thereby enabling reliable severing of the stem with a controlled and repeatable stem length. The present invention is particularly advantageous for harvesting table-grade fruits, which have precise stem length tolerances for preserving shelf life. The present invention is also advantageous for harvesting spherical soft fruits, which can sustain bruising and skin damage relatively easily with current automated techniques, lowering their market value and shelf life.

Other advantages and improvements of the present apparatus/system and method over the existing methods include an ability to hold and center the gripped crop using a single actuator. The proposed apparatus/system can cut the crops at a desirable stem length consistently, and can consistently harvest crops of varying sizes at a desired stem length. In addition, the present apparatus and/or system enables alignment of the crop stem within the cutting blades through rotational and/or translational motion of the end-effector via a robotic arm, thereby improving cutting accuracy and repeatability.

### BRIEF DESCRIPTION OF THE DRAWINGS

FIG. 1 is a block diagram of an exemplary apparatus/system for harvesting round crops in accordance with the present invention.

FIGS. 2A-C are different views of an exemplary end effector suitable for use in the present apparatus/system; FIG. 2A is a top view, FIG. 2B is a perspective view, and FIG. 2C is a side view.

FIG. 3 is a flow chart for an exemplary method of harvesting round crops using the present apparatus/system.

FIG. 4 is a block diagram of an exemplary alternative apparatus/system for harvesting round crops in accordance with the present invention.

FIG. 5 is a block diagram of an exemplary implementation of the alternative apparatus/system for harvesting round crops shown in FIG. 4.

FIG. 6 is a drawing of an exemplary implementation of the robotic arm and end effector in the alternative apparatus/system for harvesting round crops shown in FIGS. 4-5.

FIGS. 7A-C are different views of the exemplary alternative end effector in FIG. 6; FIG. 7A is a top view, FIG. 7B is a perspective view, and FIG. 7C is a side view.

FIGS. 8A-B are drawings showing the alternative end effector in FIG. 6 in different exemplary stages of operation.

FIGS. 9A-B are a flow chart for an exemplary method of harvesting round crops using the present alternative apparatus/system shown in FIGS. 4-5.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

For convenience and simplicity, the terms “part,” “portion,” and “region” may be used interchangeably but these terms are also generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

The term “round crop” refers to a crop (e.g., a fruit or vegetable) having a shape that generally increases in width from a first end to a center (e.g., a central plane of the fruit) along a linear or substantially linear axis, then generally decreases in width from the center to a second, opposite end of the fruit along the axis. Round crops include citrus fruits, such as oranges, tangerines, grapefruit, pomelos, lemons and limes; apples, pears, peaches, nectarines, kiwi fruit, persimmons, apricots, plums, loquats, guavas, figs, pomegranates, mangosteens, passion fruit, dragon fruit, avocados, tomatoes, artichokes, brussels sprouts, squash, eggplant, bell peppers, etc., although the invention is not necessarily limited to these fruits. The round crops suitable for harvesting with the present apparatus are also harvested above the ground (e.g., from a tree, a vine on a trellis or other support, etc.), so they generally exclude root crops.

For example, citrus fruits should be picked with the calyx and a partial stem remaining attached to the body of the fruit. This is important in both ripe and unripe picking conditions. When unripe fruit is harvested, proper ripening will only occur if the stem remains attached. When ripe fruit is harvested, retaining the stem on the fruit prevents access to the pulp by oxygen, bacteria, insects and other contaminants.

The present apparatus (or system) includes a camera and binocular computer vision system to detect the crop, determine its positions, and identify the orientation of the stem (and optionally of the crop itself, to facilitate placement of the stem within the V-guide). It features a gripper with three flexible fingers and a palm, designed to hold and center the crop, with the gripper components actuated by an actuator (e.g., one or more servo motors). Optionally, it may have a multi-axis linear stage to precisely guide the cutting blade(s), which may comprise a knife, a razor blade, shears, scissors, etc. In one example, the cutting blades comprise miniaturized concave shearing blades for safe and efficient cutting. The entire end effector system is mounted on a robotic arm having 3 or more degrees of freedom, which can quickly and accurately bring the end effector into proximity to the fruit, in an orientation amenable to quick alignment of the cutting mechanism with the stem. In one example, the robotic arm has 6 degrees of freedom, 3 linear or Cartesian (along orthogonal axes) and 3 angular (in 3 orthogonal planes).

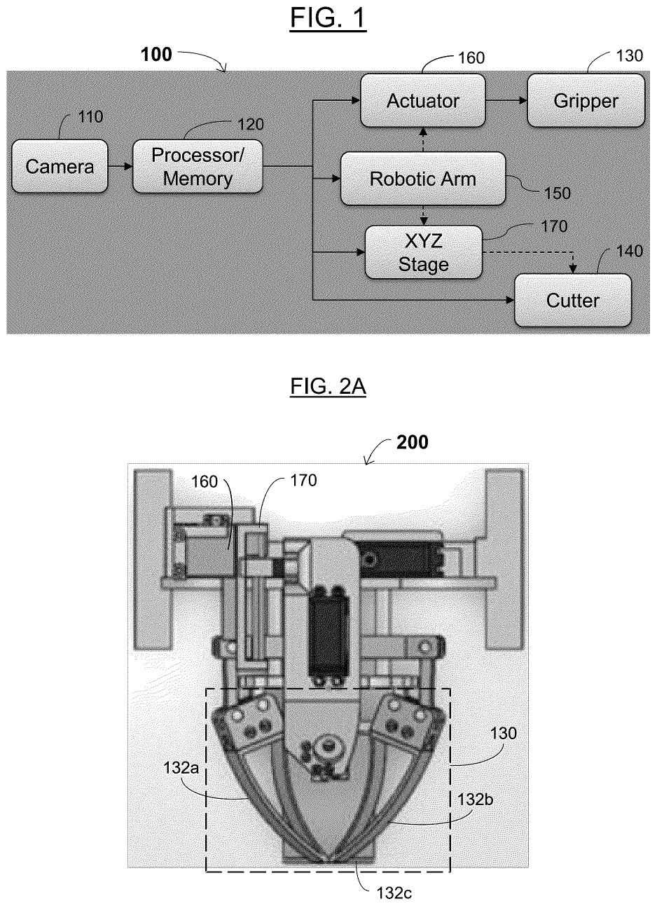

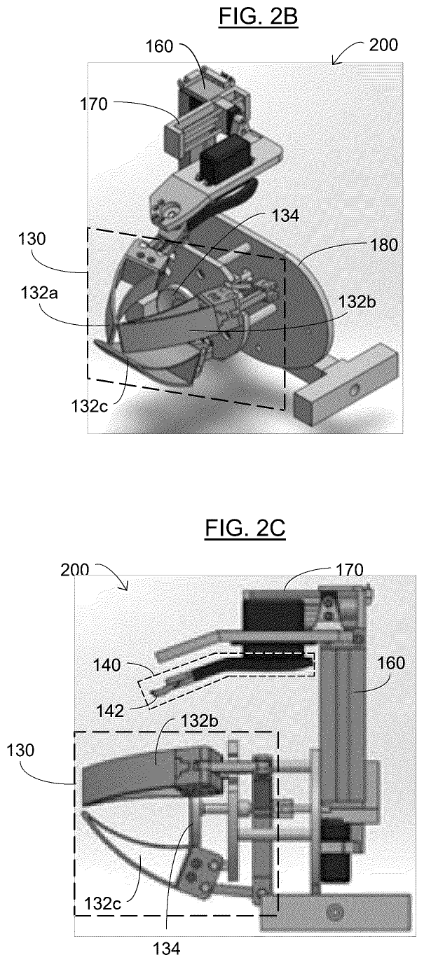

FIG. 1 shows an exemplary system 100 that includes a camera 110 and a computer (e.g., a processor and a non-transitory computer-readable medium [e.g., memory]) 120, a gripper 130, a cutter 140, and a robotic arm 150. The computer 120 implements a binocular computer vision system to detect citrus or other round fruits and vegetables, and determine and/or identify the positions and orientations of the crop and its stem. The non-transitory computer-readable medium stores a set of instructions encoded thereon that, when executed by the processor in the computer 120, is adapted to grasp and/or hold the crop and cut a stem attached thereto a predetermined distance from the crop. The gripper 130 (FIGS. 2A-C) has three or more fingers 132a-c (which may be flexible) and an optional palm 134, and is designed to hold and center the crop (e.g., a citrus fruit such as an orange). In other embodiments, the gripper may have only two fingers. All gripper components are actuated by an actuator 160, which may comprise one or more servo motors. A multi-axis linear (e.g., XY or XYZ) stage 170 precisely guides the cutter 140. The blade(s) 142 in the cutter 140 may comprise one or more concave and/or small (e.g., miniaturized) shearing blades, as described above. The end effector system 200 (i.e., the gripper 130, the cutter 140, the actuator 160 and the linear stage 170) shown in FIGS. 2A-C is mounted on the robotic arm 150 (e.g., an end thereof), which may have three or more (e.g., three to six) degrees of freedom.

The disclosed apparatus (or system) can hold/grip and center the crop using as few as a single actuator, can cut the crops at a desirable stem length (e.g., within a predetermined stem length range) consistently, and can consistently harvest crops of varying sizes at a desired stem length (e.g., within a predetermined stem length range, which can vary, depending on the crop, its variety and/or its size).

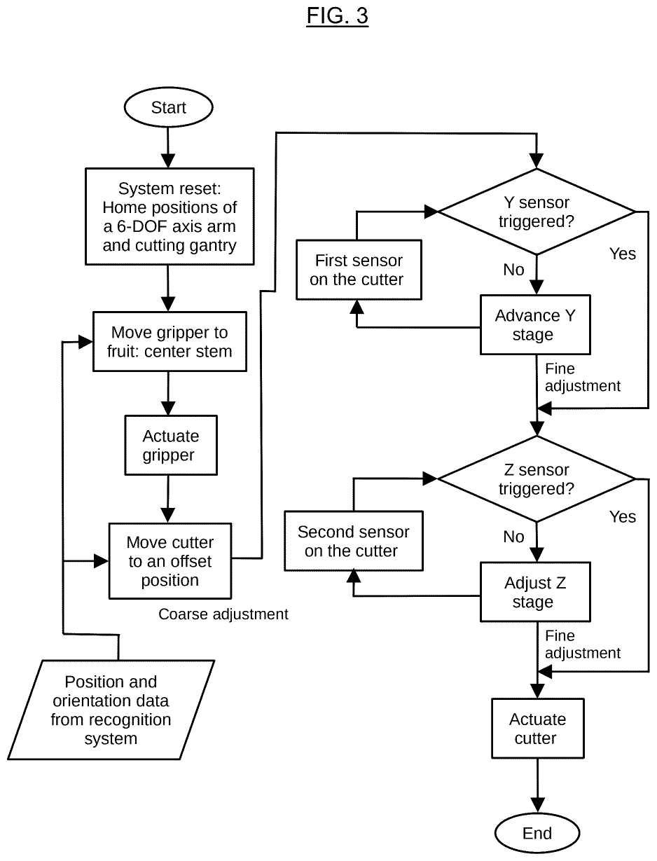

FIG. 3 is a flowchart for an exemplary method of harvesting a crop using the present apparatus. In one embodiment, the system initiates at or resets to home (e.g., fully retracted) positions for the robotic arm and the cutting gantry (e.g., the multi-axis linear stage and the cutter). Next, a recognition system (e.g., the computer vision system) determines the position and orientation of the crop to be harvested, and optionally, its stem. Preferably, the recognition system determines the position and orientation of a single crop item and the position and orientation of the stem relative to the item. The apparatus then moves the gripper to the item, and actuates the gripper. Typically, as the gripper approaches (but does not yet reach or come into contact with) the crop item, the apparatus opens the fingers so that the fingers can close around the item, then as the gripper reaches the position of the item, the fingers close on and grip the item. The amount of closing force is generally small (to avoid damaging the crop), and can be adjusted using any of several methods (e.g., sensor feedback from the gripper, empirically after accounting for the size, weight and/or shape of the crop, etc.).

Next, the linear stage moves the cutter to an offset position using a coarse adjustment mode. The offset position is generally a first predetermined distance in a first direction (e.g., along the stem) from the interface between the stem and the crop, a second predetermined distance in a direction (e.g., from the stem), generally in a second direction orthogonal from the first direction (e.g., horizontally away from the stem), and optionally a third predetermined distance in a third direction orthogonal to both the first and second directions (e.g., in embodiments in which the cutter has only a single blade). The first predetermined distance may be greater than the optimal stem length for maximizing freshness and shelf life, generally by a buffer distance (e.g., 50-100%, or 2-5 cm, greater than the optimal stem length, but the invention is not limited to such distances). The second predetermined distance may depend on a number of factors, such as the size of the crop, the dimensions of the end effector, the thickness of the stem, etc., but it may generally be in the range of 1-10 cm. The third predetermined distance may depend on the orientation of the fruit and its stem, the horizontal offset of the cutting blade(s), the number and dimension(s) of the cutting blade(s) (the second predetermined distance), and/or the same factors as the second predetermined distance, and may generally be in the range of 1-10 cm.

The cutter is secured to a multi-axis linear stage, configured to move the cutter in each of two or three orthogonal linear directions (e.g., an X direction, an orthogonal Y direction, where X and Y define a horizontal plane, and a Z direction orthogonal to that X-Y plane). Also secured to the stage or the cutter (e.g., along or at a leading edge of the cutter blade[s]) is a first sensor or switch (e.g., a pressure sensor or a limit switch) that activates on contact with an object (e.g., the stem) that imparts a force or a minimum threshold pressure on the sensor or switch as the stage and cutter move towards the stem. Alternatively, the first sensor or switch may comprise an electrical sensor or switch activated or triggered by feedback from the actuator, configured to sense or detect the presence of the stem (e.g., by monitoring an increase in the servo motor current resulting from the increased resistance when the stage or cutter contacts the stem), or a small photodetector or camera. Once the cutter is in the offset position, a fine adjustment mode of the linear stage begins to move the stage in the Y direction (e.g., away from and/or orthogonally to the base plate 180). As long as the first sensor or switch is not activated, the apparatus continues to moves the stage in the Y direction. When the first sensor or switch is activated or triggered, the apparatus stops moving the stage in the Y direction, and begins moving the stage in the Z direction, along the direction of the stem axis. Optionally, the linear stage can adjust the cutter position in the X direction, for example when the stem is not centered relative to the gripper (the cutting blade[s] may be aligned with the center of the gripper by default).

Similar to the first sensor or switch, a second sensor or switch (e.g., a pressure sensor) is operably connected to the cutter (or alternatively, to the stage) that activates in response to a minimum threshold pressure applied to the cutter (or the stage). The second sensor or switch may be similar or identical to the first sensor or switch, but configured to sense a change in force or pressure in a different direction. In one embodiment, a spacer (which may be compressible) that extends from a pressure sensor in the Z direction may have a length equal or about equal to A+B, where A is the distance in the Z direction between the pressure sensor and the cutter blade edge, and B is the optimal stem length to keep on the fruit. Alternatively, the cutter may move until it comes into contact with the skin of the crop, then the cutter may be moved in the opposite direction (e.g., raised) along the Z axis a distance equal to the optimal stem length (e.g., before actuating the cutter). In another alternative, the cutting blade(s) may have a concave shape with a depth or height along the Z axis equivalent to the optimal stem length, so that the stem can be cut when the cutting blades contact the skin of the crop. The optimal stem length is typically a range of lengths that are optimal for maximizing freshness and shelf life of the crop. For example, for oranges, the optimal stem length (including the pedicel) is 0.1-0.3 cm. As long as the second sensor or switch is not activated, the apparatus continues to move (e.g., lower) the stage in the Z direction (e.g., along the direction of the stem). When the second switch is activated or triggered, the apparatus stops moving the stage in the Z direction, and actuates the cutter. When the cutter comprises shears or scissors having two opposing blades (or one blade and an opposing straight or curved flat surface to prevent the stem from moving), the cutter is actuated by closing the gap between the blades (or the blade and the flat surface). When the cutter has only a single blade, it is actuated by moving it in the X direction until it contacts the stem, then in the Y direction (typically, back-and-forth a distance of 1-2 cm one time, although this invention is not limited to this distance, and the operating system in the apparatus can repeatedly actuate the cutter until the robot arm can move the fruit without resistance, or more than a threshold distance without resistance). When the stem is cut, the robot arm places the fruit in a container, and repeats the flow for the next piece of fruit.

An alternative end effector and harvesting system may use the robotic arm to execute a novel motion path. The robotic arm may be a foundational component of a robotic fruit harvesting system, and is generally responsible for guiding the end effector to a position in which it can interact with the target fruit. In some embodiments, the robotic arm is used primarily for coarse positioning of the end-effector and guiding it toward the fruit based on outputs from a recognition system, and fine alignment of the cutter blades with the stem is achieved using an XYZ motorized stage. However, the XYZ stage may have speed limitations, and the alternative end effector and harvesting system may significantly decrease harvesting time.

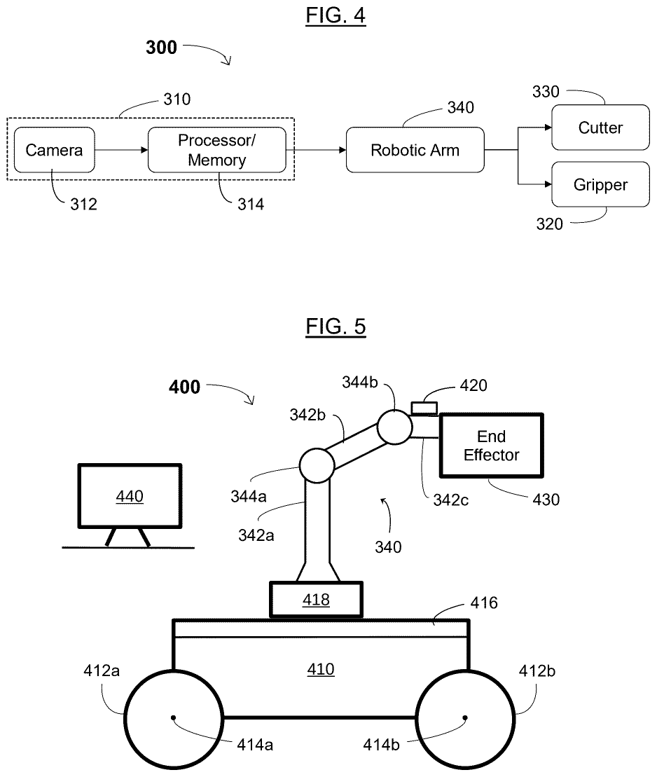

The alternative end effector and harvesting system replaces the XYZ motorized stage with a V-shaped guide that is connected or coupled to and aligned with the cutter blades. In one embodiment, the V-guide is rigidly attached to the cutting mechanism. The V-guide may extend beyond the blade(s) of the cutting mechanism, providing a larger capture region for the fruit stem, improving tolerance to positioning and orientation errors, and effectively simplifying the system 100 in FIG. 1 to the system 300 in FIG. 4.

FIG. 4 is a block diagram of an exemplary alternative harvesting system 300, comprising a binocular computer vision system 310 including camera 312 and a processor and memory 314 (e.g., as part of a computer that processes images from the camera 312); a gripper 320 with three or more fingers and a palm, designed to hold and center the fruit; a cutter or cutting mechanism 330 comprising one or more cutting blades; a V-shaped stem guide (not shown) to direct the stem towards the cutter or cutting mechanism 330; and a 6-degree-of-freedom (6DOF) robotic arm 340. The gripper 320, the cutter 330, and the stem guide form an end effector system that is mounted on a distal end of the robotic arm 340. Using software described herein and/or known in the art, the computer vision system 310 detects fruits for harvesting, determines their positions, and identifies the orientation of the stem. The fingers of the gripper 320 may be flexible (e.g., may have ends or tips gripping the fruit that comprise a rubber, such as polyisoprene, a silicone rubber, a poly[acrylonitrile-butadiene-styrene] rubber, etc.). The gripper fingers may be actuated by one or more (preferably, a single) servo motor. The cutter 330 may comprise a pair of shearing blades or a single straight or curved blade with an opposing, complementary flat, firm surface. In one example, the cutter 330 comprises a pair of small, concave shearing blades for safe and efficient cutting.

FIG. 5 is a more complete version of an exemplary alternative harvesting system 400, for use in the field (e.g., an orchard or farm). The harvesting system 400 comprises an autonomous (e.g., self-moving) platform 410, a robotic arm 340, a recognition system (e.g., an RGB depth camera) 420, an end-effector 430, and a computer system 440 configured to execute a partial or full harvesting process. The autonomous platform 410 generally includes a vehicle capable of (i) operating autonomously using a perception system separate from the recognition system 420 and (ii) executing a pre-defined or dynamically generated operational path, course or motion. The autonomous platform 410 may comprise at least three wheels 412a-b, at least one axle 414a-b on which two wheels (412a and another wheel behind wheel 412a that is not shown in FIG. 5) are mounted, at least one third wheel 412b which may also be mounted on an axle 414b and that is rotatable independently of the axle 414a, a battery-or fuel-powered motor (not shown) to drive the wheels clockwise and/or counter-clockwise, and a frame (not shown) configured to support (i) the robotic arm 340 and (ii) a conventional mechanism for raising and lowering the robotic arm 340. In some embodiments, the autonomous platform 410 may include a recognition system that can be shared with or that can replace the recognition system 420 mounted on the robotic arm 340, enabling a single recognition system to be employed for both fruit harvesting and autonomous platform operations (e.g., motion of the autonomous platform 410). In various embodiments, the mechanism for raising and lowering the robotic arm 340 comprises a first stage 416 configured to raise and lower the robotic arm 340 vertically, and an optional second stage 418 configured to extend and retract the robotic arm 340 horizontally. Either or both of the stages 416 and 418 may also rotate (or rotate the robotic arm 340) in a horizontal plane. However, depending on the capabilities and/or dimensions of the robotic arm 340, as well as the dimensions of the trees from which the fruit is to be harvested, the first and second stages 416 and 418 can be omitted.

In various embodiments, the autonomous platform 410 may further comprise a user interface (e.g., a touch screen and/or keypad) for inputting instructions to and reading information from the platform 410, a memory configured to store instructions and data, and a processor configured to process data (e.g., input into the user interface or generated by the autonomous platform 410) and execute the instructions received through the user interface or retrieved from the memory. For example, the autonomous platform 410 may comprise an Amiga system, commercially available from Farm-Ng, Watsonville, CA (store. farm-ng. com/products/la-maquina-amiga). The platform 410 positions the robotic arm 340 in proximity to (e.g., under) a tree using the perception system, and the recognition system 420 detects and localizes the fruit. In one implementation, the perception system comprises a color (e.g., RGB) binocular camera and off-the-shelf machine vision software (e.g., an Intel Realsense RGB Depth Camera D457).

The robotic arm 340 is mounted on the autonomous platform 410 (e.g., the first or second stage 416 or 418, or in some embodiments, directly onto the frame) using conventional mounting hardware or via a customized mount that enables electrical connections between the robotic arm 340 and a wireless communication module on the platform 410 that communicates wirelessly with the computer system 440. Alternatively, the computer system 440 can be integrated into the autonomous platform 410, in which case communications between the computer system 440 and components of the harvesting system 400 can be wired or wireless. The robotic arm 340 includes multiple rigid links (arms) 342a-c connected by joints 344a-b. Each of the joints 344a-b is driven by an actuator (not shown), such as a servo motor. Actuation of the joints 344a-b results in rotational and/or translational motion of the corresponding link 342b-c, resulting in controlled movement of the robotic arm 340 and corresponding positioning and motion of the end-effector 430 attached at the distal end 346 of the robotic arm 340.

Based on outputs from the recognition system 420 (which includes a camera mounted on the robotic arm 340), a controller (e.g., on board the autonomous platform 410 or in the computer system 440) controls the motion(s) of the robotic arm 340 to guide the end-effector 430 into the tree canopy and toward the target fruit. While the recognition system 420 may be mounted essentially anywhere on the robotic arm 340 or the platform 410 allowing the recognition system 420 to view fruit in the canopy of the tree (with adjustments made in the machine vision software for identifying the position of the fruit and of the end effector 430 relative to the camera in the recognition system 420), the recognition system 420 is advantageously mounted on the robotic arm 340 near the end effector 430, to minimize the possibility for obstructions between the recognition system 420 and the end effector 430 as the end effector 430 approaches the fruit to be harvested. In certain embodiments, movement of the robotic arm 340 is generated by actuating motors for the joints 344a-b based on or using conventional inverse kinematics calculations for three-dimensional motion.

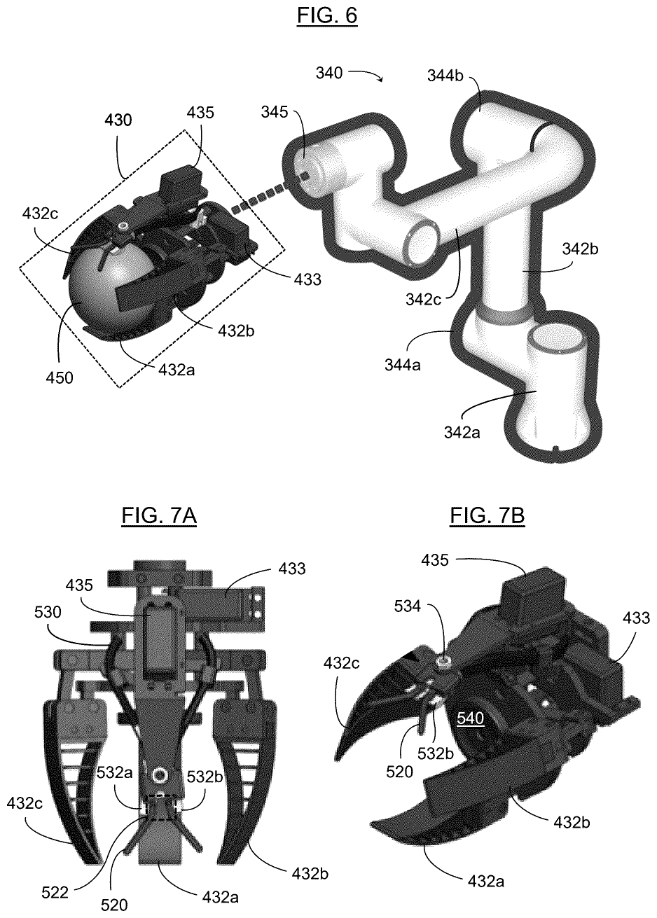

FIG. 6 is a diagram of an exemplary robotic arm 340 with an exemplary end effector 430 operably connectable thereto. The robotic arm 340 as shown includes six degrees of freedom, providing multi-axis positioning and orientation of the end-effector 430. The degrees of freedom are provided by independently actuated joints 344a-b, each driven by an actuator such as an electric motor (e.g., a servo motor, as described herein). The motors of the robotic arm 340 are generally placed at the joints 344a-b. While a six-degree-of-freedom configuration is shown in FIG. 6, the system may operate successfully with fewer (e.g., 3 or 4) degrees of freedom.

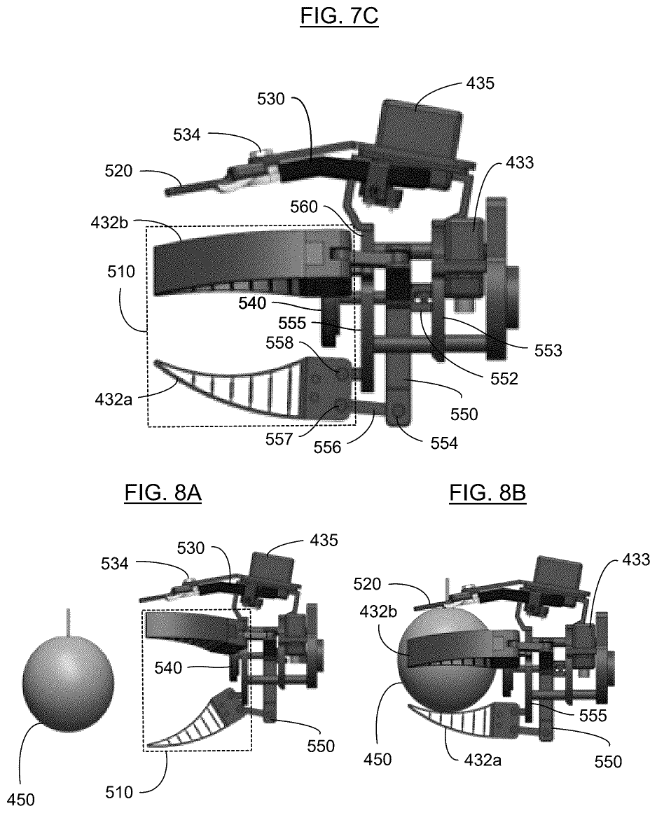

The end effector 430 is connected to the robotic arm 340 at a rotatable connector 345, and uses three gripper fingers 432a-c to grip the fruit 450 (in the case shown in FIG. 6, an orange). The end effector 430 also includes a first actuator 433 configured to cause the gripper fingers 432a-c to grip and release the fruit 450, and a second actuator 435 configured to move the blade(s) of the cutter (shown in greater detail in FIGS. 7A-C) in a cutting motion and retract the blade(s) (or allow the blade[s] to retract) to a default (e.g., open) position. The operations of the first actuator 433 and the second actuator 435 are discussed in detail with respect to FIGS. 7A-C.

FIGS. 7A-C are respectively top, perspective and side views of the exemplary end effector 430. The end effector includes a gripper 510 with three fingers 432a-c, a V-shaped guide 520 above the gripper 510, and a cutting mechanism 530 between the V-shaped guide and the gripper 510. The cutting mechanism 530 in the example shown in FIGS. 7A-C includes opposing blades 532a-b that rotate in opposite directions around a pivot point (e.g., a rod, screw or bolt 534 that secures the cutting mechanism 530 and optionally the guide 520 to the support frame of the end effector 430), and may comprise pliers, scissors, or a similar cutting mechanism with two rotatable handles or arms (not identified) that cause the blades 532a-b to cut the stem of the fruit. The end effector shown in FIGS. 7A-C also includes a cushion, pad or “palm” 540 at a base of the gripper. The pad or “palm” 540 may have a major surface that is orthogonal or substantially orthogonal to the length direction of the gripper fingers 432a-c, and may be mounted on a plate, rod and/or frame.

The first actuator 433 may open and close the gripper fingers 432a-c with a single reversible movement. As is more clearly seen in FIG. 7C, the first actuator 433 can move a movable gripper plate or frame 550 linearly along an axis defined by or parallel to a central axis of the gripper fingers 432a-c by extending a rod or bearing 552 attached to the movable gripper plate or frame 550. The mechanism for the first actuator 433 to extend the rod or bearing 552 is not particularly specific, but one embodiment, it may comprise a first arm (not identified) that rotates around an axle extending from the bottom of the housing of the actuator 433, coupled to a bearing 552 secured to the back of the movable gripper plate or frame 550. The actuator 433 may rotate or sweep the arm periodically (e.g., back and forth) across a fixed arc (e.g., from −90° to +90°, or any range of values therein [such as −60° to +60°, 0° to 90°, etc.], relative to the central axis of the gripper fingers 432a-c) to extend the movable gripper plate or frame 550 from a position near a fixed support plate 553 to a position near a fixed gripper plate 555 and back. The bearing 552 may also be connected directly or indirectly (e.g., through a rod on the movable gripper plate or frame 550) to the palm 540, which may also be activated by the first actuator 433. Alternative mechanisms for extending the rod or bearing 552 is for the first actuator 433 to extend a rod 552 using (i) a linear motor, (ii) a gear on the axle extending from the actuator housing, or (iii) a piston (e.g., a hydraulically-driven piston).

FIG. 7C shows the movable gripper plate or frame 550 in a fully extended position. As the movable gripper plate or frame 550 moves from the support plate 553 to the fixed gripper plate 555, gripper arms 556 (connected to the movable gripper plate or frame 550 and the gripper finger 432 by bearings 554 and 557, respectively) move the outer corners of the gripper fingers 432a-c outward, away from the fixed gripper plate 555. However, the inner corners of the gripper fingers 432a-c are fixed to the fixed gripper plate 555 with a short rod (not identified) connected to a bearing 558 at the inner end of the gripper finger 432. This causes the distal tips of the gripper fingers 432a-c to move inwards, grasping the fruit. When the actuator 433 rotates or sweeps an arm, the tips of the gripper fingers 432a-c move inwards with increasingly smaller incremental force as the actuator arm approaches a 0°angle relative to the central axis of the gripper fingers 432a-c. Pulling the movable gripper plate or frame 550 back towards the fixed gripper plate 555 causes the distal tips of the gripper fingers 432a-c to move outwards, away from the central axis of the gripper fingers 432a-c, releasing the fruit.

As shown in FIGS. 7A-C, the second actuator 435 opens and closes levers (e.g., handles) on the cutting mechanism 530 that cause the blades 532a-b to cut the stem of the fruit. The second actuator 435 is conventional, but may, in various embodiments, comprise a reversible servo motor that can open and close opposing levers attached to a hinged pivot point (in this case, pivot rod, screw or bolt 534)

The alternative harvesting system 300/400 may harvest fruit according to the following method. When the fruit is detected by the recognition system, the robotic arm 340 in the alternative system guides the end-effector 430 toward the fruit, accounting for both position and orientation (see, e.g., FIG. 8A). In embodiments where the V-guide 520 has a specific positional relationship with the cutter blades 532a-b (e.g., directly over, and optionally aligned with, the blades 532a-b), there is no need for precise detection and localization of the stem. The geometry of the V-guide 520 passively directs the stem into the guide 520 (and, when in the positional relationship with the cutter blades 532a-b, the cutter blades 532a-b) as the end-effector 430 approaches the fruit. When the stem is located within the V-guide 520 (see, e.g., FIG. 8B), various harvesting (e.g., positioning and cutting) strategies can be executed.

In one strategy, the gripper 510 in the end effector 430 grasps the fruit to secure it, then the cutting mechanism 530 simply cuts the stem. The V-guide 520 is fixed in position relative to the blade(s) 532 of the cutting mechanism 530 to ensure that the stem can be cut when the stem is at the base or crux of the V-guide 520. In some examples, a base 522 of the V-guide includes a channel with two parallel or substantially parallel guide bars that are spaced apart by 1.5-3 times the average or typical diameter of the stem.

In a further strategy, the gripper 510 may, after gripping the fruit, then slightly release the grip while maintaining containment, allowing the fruit to rotate freely. This ensures that the fruit has been allocated and confined within the gripper fingers 432a-c. Thereafter, the robotic arm 340 laterally vibrates (one or more back-and-forth cycles of vibration, e.g. in a horizontal plane) the end-effector 430 to prevent the stem from catching on edges of the V-guide or the cutter blades 532a-b. This may also assist in centering the stem within the V-guide 520.

While the gripper 510 maintains containment of the fruit, the robotic arm 340 then rotates the end-effector 430 downward (e.g., an oscillatory motion in the vertical plane). This results in two dimensions of motion. First, the end-effector 430 is translated forward, guiding the stem along the V-guide 520 toward the rear or base 522 of the V-guide 520 and toward the pivot point 534 of the cutter blades 532a-b. Second, the end effector 430 is translated downward by an amount determined by the estimated fruit size provided by the recognition system 420, until the calyx (or other predetermined part of the fruit) reaches or slightly passes the outermost points of the cutter blades 532a-b. To ensure even more precise positioning, a sensor estimating the contact between the blades and the fruit as described herein may be included (e.g., on or adjacent to the cutting mechanism 530).

The gripper 510 then re-grips the fruit to stabilize it. For example, a force applied by the gripper 510 on the fruit may be sufficient to prevent movement of the fruit while cutting the stem, but insufficient to damage the skin of the fruit or to the bruise the fruit. The cutter 530 is then actuated to sever the stem and detach the fruit. The detached fruit is then moved by the robotic arm 340 to a location over a collection bin (not shown), and the gripper 510 releases the fruit into the collection bin.

When securing and harvesting fruit, small additional motions in/of the system are acceptable, due to the flexibility of the stem attachment to the tree branch, and to overall system compliance. The present harvesting system is tolerant to small variations and positioning errors. Accordingly, command signals from the computer system 440 may intentionally include increased motion amplitude (e.g., of the robotic arm 340). These additional motions can result in the fruit and its stem being gently pushed into the surrounding canopy. Such tolerance is desirable in harvesting systems, because the many sources of variation among fruits, trees, environments, etc., in harvesting may be difficult to control precisely. For example, the recognition system 420 may provide imperfect localization information, the robotic arm 340 may not execute an exact commanded motion, and/or identical control commands may be applied to fruits of different sizes or stem orientations. Despite these variations, the present system remains capable of aligning the fruit stem with the cutter blades 532a-b due to the mechanical compliance and flexibility in the attachment of the stem to the tree branch.

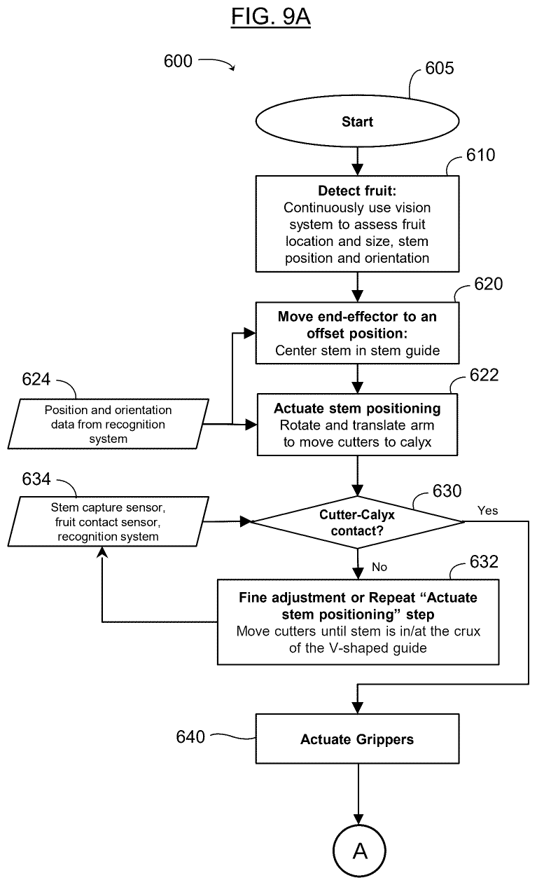

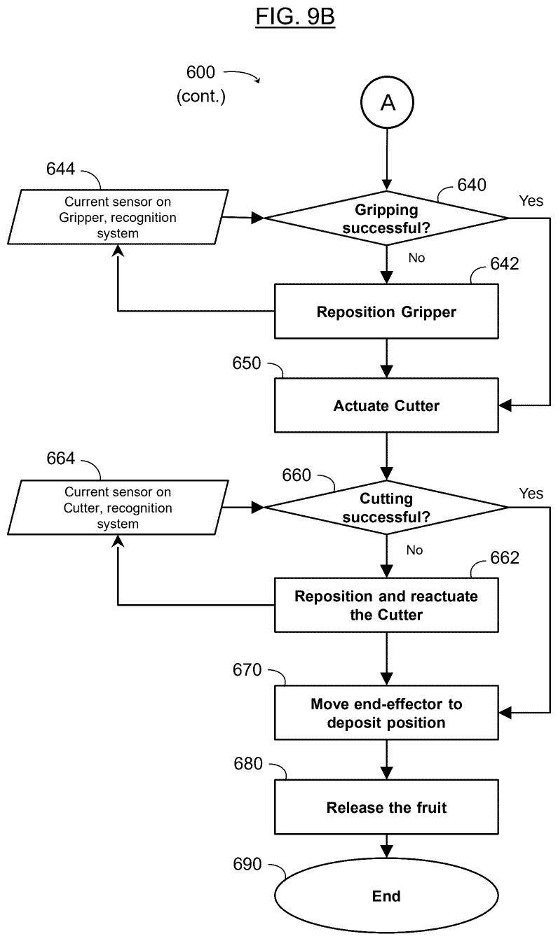

An exemplary method of harvesting fruit using the present alternative harvesting system, executable by a computer processor that executed software stored in a memory or other tangible storage medium, is shown in the flow chart 600 in FIGS. 9A-B. In general, at the start 605, the system initiates at or resets to home (e.g., fully retracted) positions for the robotic arm and the end effector. Next, at 610, the recognition system (e.g., a computer vision system) determines the location and size of the fruit to be harvested, and the position and orientation of its stem. Preferably, the recognition system determines the position, orientation and size of the fruit and the orientation of the stem continuously.

The harvesting system then moves the end effector, and in particular, the gripper, to a position slightly offset from the position of the fruit at 620, then moves the end effector so that the stem is in the V-guide. Typically, at this time, the fruit is within the gripper fingers, but the gripper fingers have not closed around the fruit. The robotic arm then actuates (i.e., rotates) the end effector at 622 to position the stem near the base or crux of the V-guide, thereby bringing the stem into a position in which the cutting mechanism can sever the stem. If desired or necessary, the robotic arm may vibrate a limited number of times (e.g., move back and forth a distance of 0.5-3 cm 1-3 times within a period of time of 0.5-3 seconds) to facilitate the positioning of the stem in the V-guide. Depending on the fruit being harvested, the cutter may be positioned an optimal distance from the point where the stem contacts the skin/flesh of the fruit. For example, when the fruit is a citrus fruit, the lower surface of the cutting mechanism may contact the calyx of the fruit, and the cutting mechanism may be designed or configured so that the blade(s) cut the stem within the optimal range of stem lengths for the fruit.

At 630, when the cutting mechanism contacts the calyx of the fruit (or the cutting mechanism is otherwise in a position to cut the stem within the optimal range of stem lengths for the fruit), the gripper is actuated to close the gripper fingers around the fruit at 640. The amount of closing force applied by the fingers is generally small and insufficient to damage the fruit, and can be adjusted as described herein. If the cutting mechanism is not in a position to cut the stem within the optimal stem length range, then the stem positioning step at 622 may be repeated, or a fine adjustment may be made at 632 to position the cutting mechanism in a better location to sever the stem at an optimal length. The fine adjustment may be made using the robotic arm, or a cutter positioning actuator, such as the actuator 160 and/or the linear stage 170 discussed with respect to FIGS. 2A-C. The adjusted position of the cutting mechanism may be determined and/or evaluated at 634 using a stem capture sensor configured to determine whether the stem is at the base or crux of the V-guide, a fruit contact sensor configured to determine whether the cutting mechanism is in contact with the fruit (or the calyx thereof), or the recognition system and computer system described herein.

At 640, when the fruit is successfully gripped (e.g., the recognition system and computer system detect each of the fingers in contact with the fruit, movement of the robotic arm or end effector causes an equal or equivalent movement of the fruit, or sensors on the inner surfaces of the tips of the fingers sense a certain pressure from contacting the fruit), the cutting mechanism is actuated at 650 to sever the stem. If the fruit is not successfully gripped at 640, then the gripper is repositioned at 642. For example, repositioning the gripper may comprise opening the gripper fingers as described herein, moving the end effector until the recognition system and computer system determine the gripper is in a more ideal position to successfully grip the fruit (e.g., the most distal edges of the gripper fingers are beyond a distal surface of the fruit, relative to the palm of the gripper), then re-closing the gripper fingers. Repositioning the gripper is evaluated at 644 by the repositioning system and computer system as described herein, or by a current sensor on or in the gripper. For example, electrical current feedback from the servo motor actuating the gripper can be correlated to the pressure exerted on the gripper fingers to determine the quality of the hold of the gripper on the fruit at 644. In an alternative implementation, two or more gripper fingers may be fitted with electrodes configured to pass a small current through the fruit. In one implementation, the electrodes are placed on the gripper fingers at a point of contact with the fruit. When the fruit is gripped correctly, the current passing through the fruit will be higher than when the fruit is not gripped correctly. A suitable minimum threshold for the current passing through the fruit when gripping is successful can be empirically determined by those having skill in the art.

After the cutting mechanism is actuated at 650, the system determines whether the stem has been successfully severed at 660. In one example, the recognition system and computer system can determine whether moving the end effector (and thus moving the fruit) also causes movement of the remaining part of the stem on the tree. If so, stem cutting was not successful; if the end effector and the fruit move independently from the remaining part of the stem, stem cutting was successful. Alternatively, the sensor(s) at the tip(s) of the gripper fingers can sense whether there is an increase in pressure when moving the fruit after the cutting operation. If so, then stem cutting was not successful; if not, then stem cutting was successful. Another method for determining successful cutting of the stem includes monitoring electrical current feedback from the servo motor in the second actuator for the cutting mechanism, where variations in the motor current are correlated with successful or unsuccessful cutting of the crop stem.

When the stem is successfully severed, the method moves to 670, and the robotic arm moves the end effector (with the fruit grasped by the gripper fingers) to a location to deposit the fruit into a collection bin or other collection container. When the stem is not severed, the fruit and/or the cutting mechanism are repositioned at 662, for example, by opening the gripper fingers, moving the end effector and gripper rotationally and/or translationally a short distance (e.g., 3-15° in any of three to six angular directions, and/or 0.1-5 cm in any of two to three Cartesian directions), and closing the fingers to regrip the fruit, or by adjusting the position of the cutting mechanism using the actuator and/or the linear stage discussed with respect to FIGS. 2A-C. Repositioning is evaluated at 664 by the repositioning system and computer system as described herein, or by a current sensor on the cutting mechanism similar to the current sensor(s) on the gripper fingers discussed above.

At 680, the fruit is released into the collection bin or other collection container, generally by positioning the end effector so that the gripper is facing downwards into the collection bin or container (which can be evaluated by the recognition system and computer system), then opening the gripper fingers. At 690, the method ends, but in typical use, goes back to the start 605 and resets components of the system (e.g., the robotic arm and the end effector) to home positions.

A further aspect of the present invention relates to algorithms, computer program(s), computer-readable media and/or software, implementable and/or executable in a general-purpose computer or workstation equipped with a conventional digital signal processor or microprocessor, configured to perform one or more of the harvesting methods and/or one or more operations of the harvesting system hardware disclosed herein. Thus, a further aspect of the invention relates to algorithms and/or software that create and/or implement part or all of any method disclosed herein. For example, the computer program or computer-readable medium generally contains a set of instructions which, when executed by an appropriate processing device (e.g., a signal processing device, such as a microcontroller, microprocessor or DSP device), is configured to perform the method(s) and/or operation(s) described herein.

The computer-readable medium may comprise any medium that can be read by a signal processing device configured to read the medium and execute code stored thereon or therein, such as a flash drive, floppy disk, CD-ROM, magnetic tape or hard disk drive. Such code may comprise object code, source code and/or binary code. The code is generally digital, and is generally configured for processing by a conventional digital data processor (e.g., a microprocessor, microcontroller, or logic circuit such as a programmable gate array, programmable logic circuit/device or application-specific integrated circuit [ASIC]).

Thus, an aspect of the present invention relates to a non-transitory computer-readable medium, comprising a set of instructions encoded thereon or therein and, when executed by a processing device as described herein, is adapted to practice the method of harvesting fruit, including any of the details discussed with respect to FIGS. 3 and 9A-B. In essence, the set of instructions encoded on the computer-readable medium may implement substantially any function of any hardware described herein, and may perform any part of any method described herein that is performed by the harvesting system.

The present invention is particularly advantageous for fruits such as citrus fruits that should be picked with the calyx and a partial stem within a predetermined length range remaining attached to the body of the fruit. This is important in both ripe and unripe picking conditions. When the fruit is unripe, proper or optimal ripening is maximized when the stem remains attached. When the fruit is ripe, the stem prevents access to the pulp by oxygen, bacteria, insects and other contaminants. The present harvesting system can also (1) hold and center the gripped fruit using a single actuator, (2) cut the fruits at a desirable stem length consistently, and (3) harvest fruits of varying sizes consistently within a predetermined stem length range.

The economic potential of and/or commercial applications for the invention include the following. Integrating the proposed end effector into a new or existing harvesting system enables for high-quality citrus and other round fruit to be picked in an automated fashion. The present harvesting system enhances the picking of fruits, and particularly citrus fruits, maximizing their freshness and the length of their freshness and shelf life. Maintaining the quality of the product allows farmers to market the fruit as table grade, which in turn maximizes their profits. The present apparatus and method can alleviate issues with availability of seasonal workers, ensuring citrus and other round fruits are picked on time and in a cost-effective manner. Farmers can achieve continuous, around-the-clock harvesting operations, as labor laws and regulations are not applicable to harvesting robotics.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A fruit harvesting system, comprising:
a platform;
a robotic arm mounted on the platform, the robotic arm having a plurality of degrees of freedom;
an end effector configured to grasp a fruit and sever a stem of the fruit, the end effector being operably connected to the robotic arm and comprising:
a gripper having a plurality of rotatable fingers configured to open and close around the fruit, and
a cutting mechanism configured to sever the stem of the fruit when the rotatable fingers close around the fruit; and
a recognition system configured to identify a location of the fruit and instruct the robotic arm to guide the end effector to the location of the fruit.

2. The fruit harvesting system of claim 1, wherein the end effector further comprises a V-shaped guide configured to guide the stem into a cutting position in the cutting mechanism.

3. The fruit harvesting system of claim 2, wherein the cutting mechanism comprises first and second opposing blades, or a blade and an opposing surface, configured to cut the stem by moving towards each other, and the V-shaped guide has a base or crux that at least partially overlaps (i) the first and second opposing blades or (ii) the blade and the opposing surface.

4. The fruit harvesting system of claim 1, wherein the robotic arm has three or more degrees of freedom.

5. The fruit harvesting system of claim 1, wherein the gripper comprises three or more gripper fingers, each configured to rotate to open and close the gripper around the fruit.

6. The fruit harvesting system of claim 5, wherein the gripper further comprises a palm, designed to hold and center the fruit in combination with the gripper fingers.

7. The fruit harvesting system of claim 5, wherein the end effector further comprises a first actuator configured to cause the gripper fingers to grip and release the fruit.

8. The fruit harvesting system of claim 7, wherein:
the end effector further comprises a fixed gripper plate, a movable gripper plate or frame, and a rod or bearing attached to the movable gripper plate or frame, and
the first actuator is configured to move the movable gripper plate or frame linearly along an axis defined by or parallel to a central axis of the gripper fingers by extending the rod or bearing.

9. The fruit harvesting system of claim 8, wherein each of the gripper fingers is hingedly connected to each of the fixed gripper plate and the movable gripper plate or frame.

10. The fruit harvesting system of claim 3, wherein the end effector further comprises a second actuator configured to move (i) the first and second blades or (ii) the blade and the opposing surface towards and away each other.

11. The fruit harvesting system of claim 1, further comprising a computer system configured to receive image data from the recognition system, identify the fruit from the image data, determine a position of the fruit and identify an orientation of the stem the image data and positioning information, and control motion of the robotic arm to guide the end effector toward the fruit.

12. The fruit harvesting system of claim 1, wherein the platform is autonomous.

13. The fruit harvesting system of claim 1, wherein the robotic arm includes a plurality of links or arms, and adjacent ones of the links or arms are connected by a joint.

14. The fruit harvesting system of claim 13, further comprising an actuator for each said joint, configured to drive said joint and rotationally and/or translationally move a corresponding one of the links or arms.

15. A method of harvesting fruit, comprising:
detecting a fruit connected to a tree through a stem using a recognition system;
moving an end effector using a robotic arm to a position offset from the fruit, the end effector comprising:
a gripper having a plurality of rotatable fingers configured to open and close around the fruit, and
a cutting mechanism configured to sever the stem of the fruit when the rotatable fingers close around the fruit;
gripping the fruit with the gripper; and
severing the stem with the cutting mechanism.

16. The method of claim 15, further comprising adjusting the position of the end effector so that the stem enters a V-guide on the end effector, the V-guide being aligned with and/or positioned adjacent to the cutting mechanism so that the cutting mechanism can sever the stem when the stem is in the V-guide.

17. The method of claim 15, wherein detecting the fruit comprises generating image data of the fruit and its surrounding environment with a camera in the recognition system, transferring the image data to a computer system, and processing the image data with the computer system to recognize and determine locations of the fruit and the stem and determine an orientation of the stem.

18. The method of claim 17, wherein moving the end effector comprises sending one or more instructions from the computer system to the robotic arm to move in a plurality of directions until the end effector is in the position offset from the fruit.

19. The method of claim 15, further comprising vibrating the end-effector to undergo one or more lateral or angular motions to facilitate movement of the stem towards a crux or base of the V-guide, and actuating the end-effector to bring the cutting mechanism into contact with the stem.

20. A non-transitory computer-readable medium, comprising a set of instructions encoded thereon or therein and, when executed by a processing device, is adapted to practice the method of claim 15.
